(19) United States
(12) Patent Application Publication
(10) Pub. No.: US 2011/0060646 A1
(43) Pub. Date: Mar. 10, 2011

(54) AUCTION SYSTEM FOR USE OF ADVERTISING AREAS ON INTERNET AND METHOD OF OPERATING THE AUCTION SYSTEM

(76) Inventor: Yon Ho Park, Seoul (KR)

(21) Appl. No.: 12/517,046

(22) PCT Filed: Jul. 10, 2008
(86) PCT No.: PCT/KR08/04070

§ 371 Date: May 29, 2009

(30) Foreign Application Priority Data
Dec. 26, 2007 (KR) 10-2007-0137100

(51) Int. Cl. G06Q 30/00

(52) U.S. Cl. 705/14.46

(57) ABSTRACT

Disclosed herein is an auction system for the use of an advertising area on the Internet. The auction system includes an auction server and a plurality of advertiser clients. The auction server is installed on the Internet, provides a plurality of advertising areas to each member who has subscribed to post an advertisement, and selects one member who will post an advertisement from among members who participate in an auction in order to use each of the plurality of advertising areas and post an advertisement therein. The advertiser clients connect with the auction server, subscribe as members for the posting of advertisements, search the plurality of advertising areas, select one from among the plurality of advertising areas, and enter bidding prices for the selected advertising area.

### TECHNICAL FIELD

The present invention relates, in general, to an auction system for the use of advertising areas on the Internet and a method of operating the auction system. More particularly, the present invention relates to an auction system for the use of advertising areas on the Internet and a method of operating the auction system, in which the manager of an advertising area provides information about the advertising area over the Internet and the advertising area is used through auction-type competition between advertiser clients. Therefore the manager of the advertising area on the Internet can maximize advertisement profits, and the advertiser clients use the advertising area on the Internet, thereby achieving expected advertising effects.

### BACKGROUND ART

Hitherto, in order to use a specific advertising area of a specific web site on the Internet, a contract is made between advertiser clients and an Internet advertisement system in such a way that designated advertising fees, based on the size and location of the advertising area, are charged through the Internet advertisement system of a specific web site manager or the Internet advertisement system of an advertisement agency acting for a specific web site manager. Another contract may be made between the web site manager of the specific web site and the Internet advertisement system, and then an advertisement is posted, with the result that it is impossible to maximize the acceptance of orders for advertisement. Furthermore, even when one or more advertiser clients who have specific purposes and desire to use the specific advertising area of a web page of the specific web site manager are selected using the above-described advertiser client selection method and then advertisements are posted therein, the advertiser clients advertisements may not be posted exclusively or may not be posted at frequencies desired by the advertiser clients, with the result that it is difficult to achieve the advertising effects expected by the advertiser clients.

As a result, a more practical and useful scheme for enabling the manager of a specific advertising area on the Internet to maximize advertisement profits using his or her advertising area on the Internet and enabling one or more advertiser clients to use the specific advertising area, even if the advertiser clients pay slightly higher advertising fees than competing advertiser clients pay as a result of the auction, thereby achieving expected advertising effects, is keenly required.

### DISCLOSURE OF INVENTION

### Technical Problem

Accordingly, the present invention has been made keeping in mind the above problems occurring in the prior art, and the present invention is intended to provide a system and method that is configured such that an auction for the use of an advertising area on the Internet is performed between advertiser clients, and the advertising area on the Internet is provided to one or more advertiser clients selected according to their bidding price. Therefore, a web-site manager who provides the advertising area on the Internet can maximize advertisement profits using his or her own advertising area on the Internet, and the advertiser clients use the desired advertising area on the Internet through the auction, thereby achieving expected advertising effects and enabling the strategic management of advertising.

### Technical Solution

In order to accomplish the above object, the present invention provides an auction system for the right to use an advertising area on the Internet, the auction system selecting one or more advertiser clients, who have subscribed as members, have participated in bidding and will post advertisements, through an auction. The auction system includes an auction server located on the Internet, a database unit, a bidding processing unit, and an advertisement transmission unit.

The auction server includes a bidding interface unit for providing a plurality of advertising areas to the advertiser clients, providing detailed information including a number of exposures, a number of clicks, a lowest bidding price, and an average click rate (where the average click rate is calculated based on a rate of the number of exposures to the number of clicks, that is, a number of times Internet users select an advertisement exposed in the advertising area) for a past unit period for each of the plurality of advertising areas to the advertiser clients, and providing and receiving bidding details.

The bidding details include bidding prices of the remaining advertiser clients participating in an auction for the right to use the advertising area selected by the advertiser client, a click rate, which was obtained during a specific period in which an advertisement had been posted, to the advertiser clients, a bidding price for an advertising area and location information of the advertising area.

The database unit is configured to store bidding details, corresponding to the advertising area selected by the advertiser clients, input to the bidding interface unit.

The bidding processing unit is configured to select one or more advertiser clients who will post advertisements in the advertising area in an order based on the advertiser clients bidding price recorded in the bidding details, which is stored in the database unit; and a maximum profit rate (where maximum profit rate=bidding price click rate), which is stored in the database unit and which is a numerical value that is calculated using a click rate obtained during a specific period in which the advertiser clients had posted advertisements.

The advertisement transmission unit is configured to send advertiser clients advertisements, selected by the bidding processing unit, to the advertising area.

In order to accomplish the above object, the present invention provides a method of operating an auction system for the right to use an advertising area on the Internet, the auction system selecting one or more advertiser clients, who have subscribed as members, have participated in bidding and will post advertisements, through an auction, the auction system including an auction server located on the Internet. The method includes a first step of a bidding interface unit of the auction server providing a plurality of advertising areas to the advertiser clients, providing detailed information including a number of exposures, a number of clicks, a lowest bidding price, and an average click rate (where the average click rate is calculated based on a rate of the number of exposures to the number of clicks, that is, a number of times Internet users select an advertisement exposed in the advertising area) for a past unit period for each of the plurality of advertising areas to the advertiser clients, and providing bidding details, including bidding prices of the remaining advertiser clients who participate in an auction for the right to use the advertising area selected by the advertiser client, and a click rate, which was obtained during a specific period in which an advertisement had been posted, to the advertiser clients; a second step of the advertiser clients selecting any one from among the plurality of advertising areas provided by a bidding interface unit of the auction server, and a bidding interface unit of the auction server receiving bidding details, including bidding prices, entered for the selected advertising area by the advertiser clients, and location information of the selected advertising area; a third step of a database unit of the auction server storing bidding details input to the bidding interface unit; a fourth step of a bidding processing unit of the auction server checking whether the end of an auction period has been reached, and selecting one or more advertiser clients to post advertisements in the advertising area in an order based on a bidding price of the bidding details, which is stored in the database unit and which corresponds to the advertising area selected by the advertiser clients, and a maximum profit rate (where maximum profit rate=bidding price click rate), which is stored in the database unit and which is a numerical value that is calculated using a click rate obtained during a specific period in which the advertiser clients had posted advertisements; and a fifth step of an advertisement transmission unit of the auction server sending advertiser clients advertisements, selected by the bidding processing unit, to the advertising area.

### ADVANTAGEOUS EFFECTS

According to the present invention, an auction for the right to use an advertising area on the Internet is performed between advertiser clients, and the advertising area on the Internet is provided to one or more advertiser clients selected according to their bidding price, with the result that a manager, who provides the advertising area on the Internet, can maximize advertisement profits using his or her own advertising area on the Internet, and the advertiser clients use a desired advertising area on the Internet, thereby achieving expected advertising effects and enabling the strategic management of advertising.

### BRIEF DESCRIPTION OF THE DRAWINGS

FIG. 1 is a diagram showing the configuration of an auction system for the right to use an advertising area on the Internet according to an embodiment of the present invention;

FIG. 2 is a diagram showing an example of the display of a web site and web page list that is performed in the bidding process of the auction system shown in FIG. 1;

FIG. 3 is a diagram showing an example of the display of the advertising areas of a web page that is selected in the bidding process of the auction system shown in FIG. 1;

FIGS. 4 and 5 are diagrams showing an example of the display of bidding details for an advertising area that is selected in the bidding process of the auction system according to the present invention;

FIG. 6 is a flowchart showing a method of operating the auction system for the right to use an advertising area on the Internet according to another embodiment of the present invention;

FIG. 7 is a detailed flowchart showing the step of checking the deposit account of an advertiser client in the auction system operation method shown in FIG. 6; and

FIG. 8 is a detailed flowchart showing the step of selecting an advertiser client who will post an advertisement in an advertising area in the auction system operation method shown in FIG. 6.

### MODE FOR THE INVENTION

Preferred embodiments of the present invention will be described in detail below with reference to the accompanying drawings.

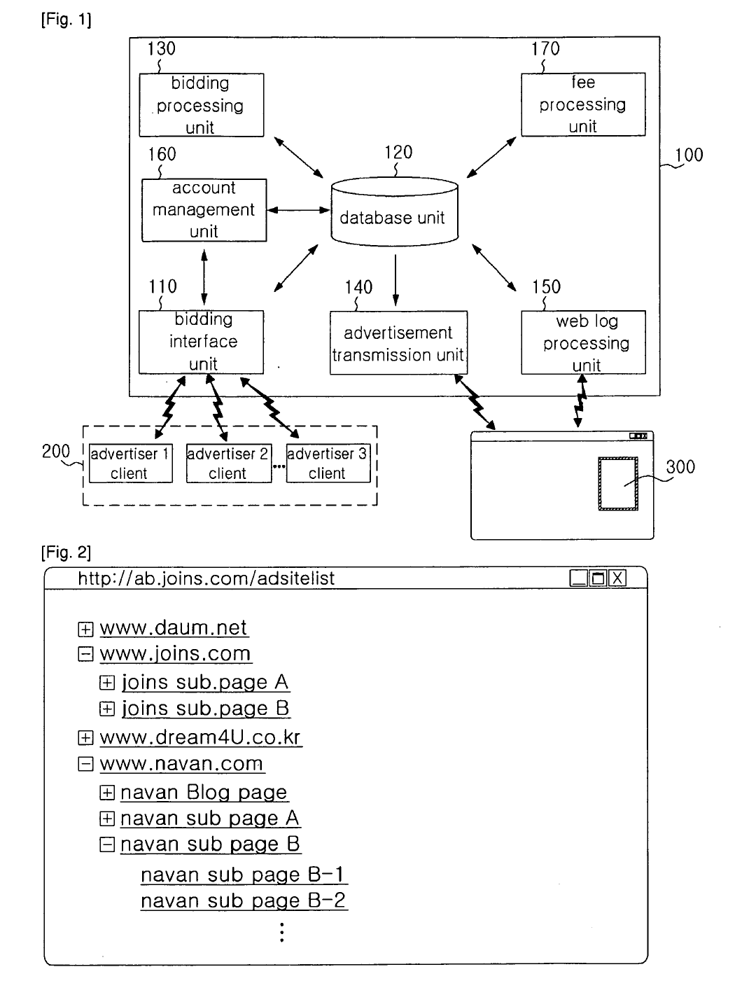

FIG. 1 is a diagram showing the configuration of an auction system for the right to use an advertising area on the Internet according to an embodiment of the present invention.

The auction system for the right to use an advertising area on the Internet according to an embodiment of the present invention includes an auction server 100 configured to be installed on the Internet, provide a plurality of advertising areas 300 to each member who has subscribed to post an advertisement, and select one or more members who will post an advertisement from among the members who participate in an auction in order to use each of the plurality of advertising areas 300 and post an advertisement therein; and a plurality of advertiser clients 200 configured to connect with the auction server 100, subscribe as members for the posting of advertisements, search the plurality of advertising areas 300, select one from among the plurality of advertising areas 300, and enter bidding prices for the selected advertising area.

In greater detail, the auction server 100 includes a bidding interface unit 110, a database unit 120, a bidding processing unit 130, and an advertisement transmission unit 140. The auction server 100 further includes a web log processing unit 150, an account management unit 160 and a fee processing unit 170.

The bidding interface unit 110 provides the plurality of advertising areas to an advertiser client 200 so that the advertiser client 200 can select any one advertising area 300 from among the plurality of advertising areas, and receives a bidding price for the advertising area 300 that is selected and entered by the advertiser client 200.

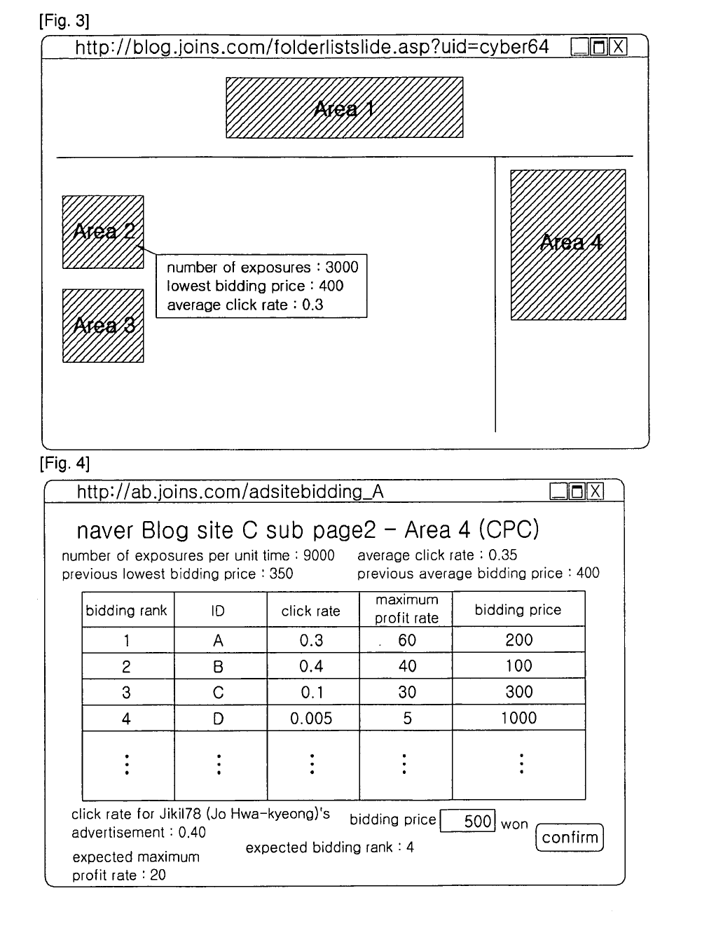

FIG. 2 is a diagram showing an example of the display of a web site and web page list that is performed in the bidding process of the auction system according to the present invention, and FIG. 3 is a diagram showing an example of the display of the advertising areas of a web page that is selected in the bidding process of the auction system according to the present invention.

As shown in FIG. 2, the bidding interface unit 110 further provides a web site and web page list corresponding to the plurality of advertising areas 300 to the advertiser client 200. The web site and web page list corresponding to the plurality of advertising areas 300 is provided in the form of a tree structure similar to that of Windows Explorer, and thus the advertiser client 200 can easily search for desired web sites and web pages.

As shown in FIG. 3, the bidding interface unit 110 further provides detailed information, such as the number of exposures, number of clicks, lowest bidding price and average click rate per period, for each of the plurality of advertising areas 300 and each of the Internet advertiser clients 200 determines whether to participate in an auction based on the detailed information.

The number of exposures is the number of times one or more advertisements are exposed to Internet users through the advertising area 300 per period.

The lowest bidding price is the lowest of the bidding prices of advertiser clients 200 who have posted advertisements in the advertising area 300 in the above-described auction period.

The average click rate is the rate of the number of exposures, that is, the number of times one or more advertisements are exposed to Internet users through the advertising area 300 per period, to the number of clicks, that is, the number of times Internet users select the exposed advertisements.

When the advertiser client 200 selects a specific web site, web page and advertising area 300 and determines to make a bid, the bidding interface unit 110 enables a bidding price for the advertising area 300, selected by the advertiser client 200, to be entered.

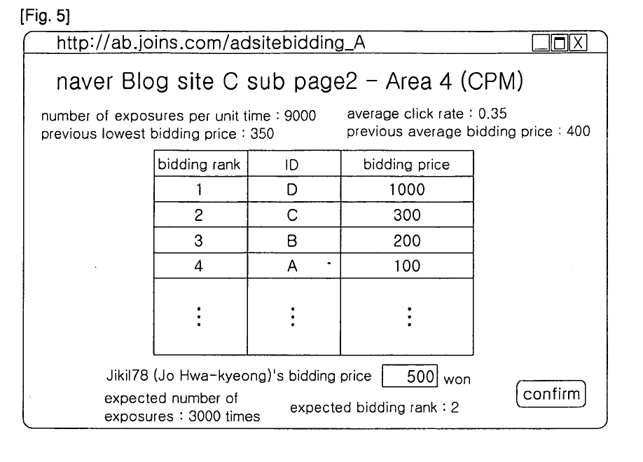

FIGS. 4 and 5 are diagrams showing examples of the display of bidding details for an advertising area that is selected in the bidding process of the auction system according to the present invention.

As shown in FIGS. 4 and 5, the bidding interface unit 110 further provides the bidding details of the other advertiser clients 200 who have participated in an auction for the selected advertising area 300 to the advertiser client 200, such as a bidding price, maximum profit rate and click rate.

Furthermore, when a selection is performed in an auction, the bidding interface unit 110 receives the advertisement that will be posted in the advertising area 300.

The database unit 120 stores bidding details, including the bidding price, the click rate and the maximum profit rate, received from the bidding interface unit 110, and the location information of the selected advertising area 300, and stores the detailed information of each advertising area 300.

Furthermore, the database unit 120 stores the number of exposures and the number of clicks for the advertisement posted in the advertising area 300, which are collected by the web log processing unit 150. The exposure information includes the number of exposures for the advertisement, and the click information includes the number of clicks for the advertisement. The exposure and click information is provided to the advertiser client 200 through the bidding interface unit 110.

The database unit 120 also stores an advertisement that will be posted in the advertising area 300.

The bidding processing unit 130 selects an advertiser client 200 who will post an advertisement in the advertising area 300 based on the bidding details stored in the database unit 120.

The bidding processing unit 130 selects an advertiser client 200 to post an advertisement in the advertising area 300 in the order of any one of the bidding price and the maximum profit rate, which is calculated based on bidding details including the bidding price and the click rate.

In the case where an advertiser client is selected based on the maximum profit rate, the maximum profit rate is a numerical value that is calculated based on the click rate and the bidding price in a specific period in which the advertiser client 200 has posted an advertisement, and the click rate is a numerical value that is calculated based on the rate of the number of exposures for the advertisement to the number of clicks for the advertisement (the maximum profit rate=bidding price click rate). If there is a history in which the same advertisement was posted in the advertising area 300 selected by the advertiser client 200, the maximum profit rate is calculated using the click rate that was obtained during the period in which the advertisement had been posted.

Alternatively, the advertiser client may be selected based on the bidding price.

The bidding processing unit 130 selects one or more advertiser clients based on the bidding details.

The bidding processing unit 130 periodically selects again one or more advertiser clients 200 to post one or more advertisements in the advertising area 300 for every specific period set in the auction server 100.

The advertisement transmission unit 140 sends the advertisement of the advertiser client 200, selected by the bidding processing unit 130, to the advertising area 300. The advertisement transmission unit 140 sends the advertisement, stored in the database unit 120, to the designated advertising area 300. In the case where two or more advertiser clients 200 are selected for the advertising area 300, the advertisement transmission unit 140 sends advertisements to the advertising area 300 at the different rates of exposure of the advertisements in the order of the bidding price or of the maximum profit rate.

The web log processing unit 150 collects the number of exposures and the number of clicks for the advertisement, sent by the advertisement transmission unit 140, and stores the information in the database unit 120.

The account management unit 160 checks the balance of the deposit account of the advertiser client 200, and requests the advertiser client 200 to deposit advertising fees if the balance is less than the minimum balance previously set in the auction server 100.

The fee processing unit 170 performs the settlement of advertisement costs for the advertiser client 200 based on the number of exposures and the number of clicks for the advertisement, which is collected by the web log processing unit 150.

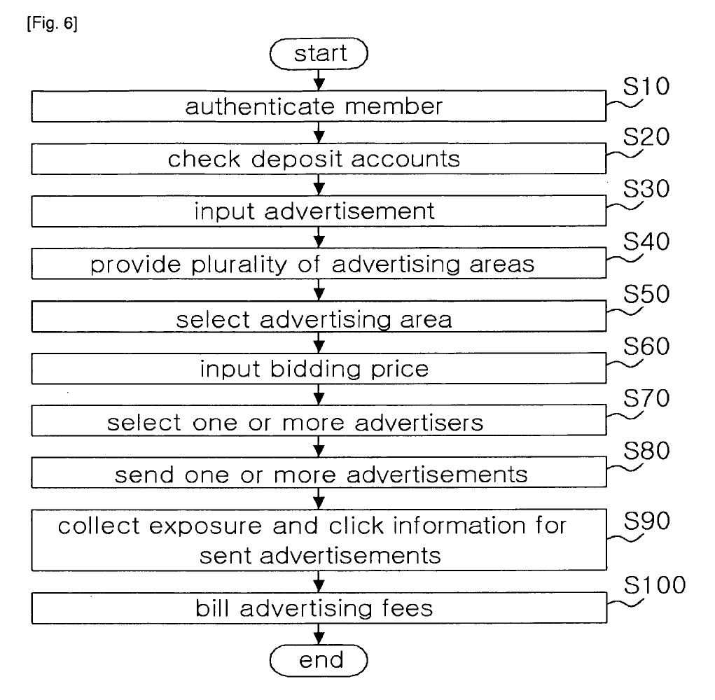

FIG. 6 is a flowchart showing a method of operating the auction system for the use of an advertising area on the Internet according to another embodiment of the present invention. The method of operating the auction system for the use of advertising area on the Internet, which includes the auction server for providing advertising areas to an advertiser client over the Internet, will be described below.

As shown in FIG. 6, the method of operating the auction system for the right to use at least one advertising area 300 on the Internet according to an embodiment of the present invention includes, in the method operating the auction system for the use of the advertising area on the Internet, the auction system including an auction server for providing the advertising area to each of a plurality of advertiser clients over the Internet, step S40 of the bidding interface unit 110 of the auction server 100 providing a plurality of advertising areas 300 on the Internet to an advertiser client 200, step S50 of the advertiser client selecting any one from among the plurality of advertising areas 300 provided by the bidding interface unit 110 of the auction server 100, step S60 of the bidding interface unit 110 of the auction server 100 receiving a bidding price for the selected advertising area 300 from the advertiser client 200, step S70 of the bidding processing unit 130 of the auction server 100 selecting one advertiser client 200 to post an advertisement in the advertising area 300, and step S80 of the advertisement transmission unit of the auction server 100 sending the advertisement of the selected advertiser client 200 to the advertising area 300.

The method further includes, before step S40, step S10 of the bidding interface unit 110 of the auction server 100 receiving subscriptions for membership from each of the advertiser clients 200 who connect to the auction server 100, step S20 of the account management unit 160 of the auction server 100 checking the balance of the deposit account of each of the advertiser clients 200, and step S30 of the bidding interface unit 110 of the auction server 100 receiving an advertisement from each of the advertiser clients 200. Furthermore, the method further includes, after step S80, step S90 of the web log processing unit 150 of the auction server 100 collecting the number of exposures and the number of clicks for the advertisement sent to the advertising area 300, and step S100 of the fee processing unit 170 of the auction server 100 performing the settlement of the advertising fees for the advertiser client 200 based on the number of exposures and the number of clicks for the advertisement collected by the web log processing unit 150.

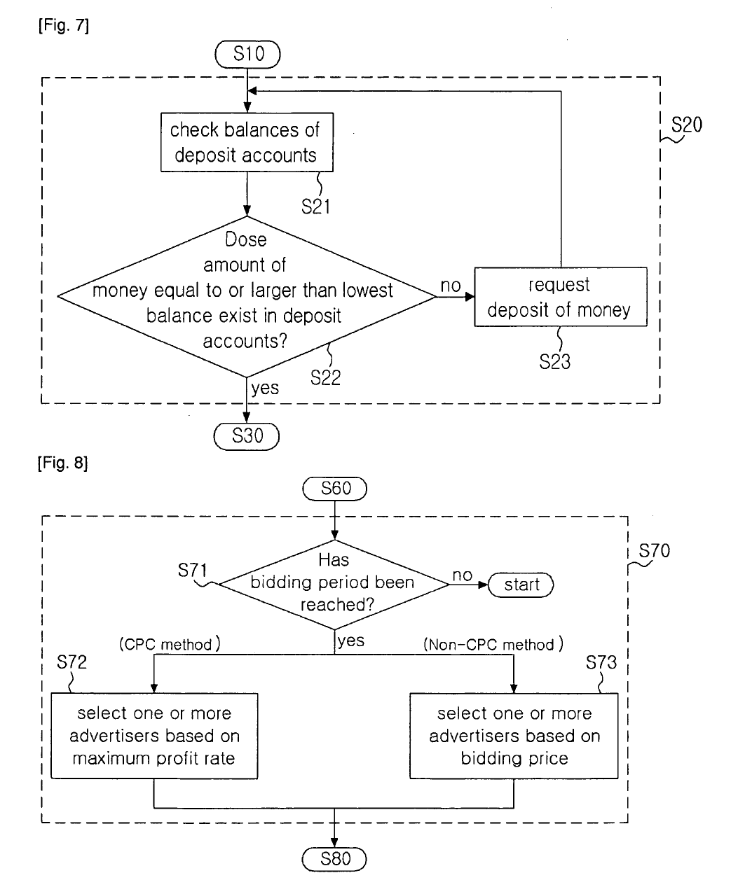

In more detail, at step S10 each advertiser client 200 connects to the auction server 100 and then subscribes as a member at the bidding interface unit 110 in order to participate in an auction for the advertising area 300. In the case of an advertiser client 200 who is registered as a member, step S20 is performed, while, in the case of an advertiser client who is not registered as a member, step S20 is performed after a subscription for membership is completed in step s10. Step S20, as shown in FIG. 7, includes the account management unit 160 of the auction server 100 checking whether an amount of money equal to or greater than the minimum balance for the posting of an advertisement is deposited in the deposit account of the advertiser client 200 at step S21. If an amount of money equal to or larger than the minimum balance designated by the auction server is not deposited in the deposit account, the advertiser client 200 is requested to deposit advertising fees equal to or greater than the minimum balance at steps S22 and S23.

At step S30, the bidding interface unit 110 of the auction server 100 receives the advertisement to be posted in the advertising area 300 from the advertiser client 200, when an advertiser client 200 is selected as the advertiser client who will post an advertisement at step S70.

At step S40, the bidding interface unit 110 of the auction server 100 provides a plurality of advertising areas 300 on the Internet to the advertiser client 200. Furthermore, a list of a plurality of web sites and web pages corresponding to the plurality of advertising areas 300 is provided. The list of the plurality of web sites and web pages is provided in the form of a tree structure similar to that of Windows Explorer, and thus the advertiser client 200 can easily search for desired web sites and web pages. Detailed information, including the number of exposures, the number of clicks, the lowest bidding price and average click rate per period for an advertisement for each of the advertising areas 300 is further provided, and each of the advertiser clients 200 determines whether to makes a bid based on the detailed information.

Furthermore, the bidding details, including bidding price and the maximum profit rate, of the other advertiser clients who participate in an auction for the selected advertising area 300 is provided to the advertiser client 200.

At step S50, the advertiser client 200 selects a desired advertising area 300 with reference to the list of a plurality of web sites and web pages and the detailed information of advertising areas 300 designated for each web page, which is provided by the bidding interface unit 110.

At step S60, when each of the advertiser clients 200 selects a desired web site, web page and advertising area 300, the advertiser client 200 inputs a bidding price for the selected advertising area 300 with reference to the bidding details of the other advertiser clients 200, such as a bidding price and the maximum profit rate, which are provided by the bidding interface unit 110.

At step S70, the bidding processing unit 130 selects the advertiser client 200 in the order of the maximum profit rate or bidding price, which is calculated from the bidding details, including the bidding price and the click rate.

Step S70 includes step S71 of the bidding processing unit 130 of the auction server 100 checking whether the end of an auction period has been reached, step S72 of the bidding processing unit 130 of the auction server 100 selecting the advertiser client 200 in the order of the maximum profit rate, and step S73 of the bidding processing unit 130 of the auction server 100 selecting the advertiser client 200 in the order of the bidding price.

At step S70, the advertiser client who will post an advertisement in the advertising area 300 is periodically selected again by periodically repeating step S71, step S72, and step S73.

As shown in FIG. 8, the bidding processing unit 130 of the auction server 100 checks whether or not an auction period has begun at step S71. If the auction period has not been begun, the bidding processing unit 130 returns to the start step and then enters a standby state. If the auction period has begun, the bidding processing unit 130 selects an advertiser client 200 to post an advertisement in the advertising area 300.

The selection of the advertiser client 200 is divided into two steps according to a method of calculating advertising fees: step S72 of the bidding processing unit 130 of the auction server 100 selecting an advertiser client 200 in the order of the maximum profit rate, and step S73 of the bidding processing unit 130 of the auction server 100 selecting an advertiser client 200 in the order of the bidding price.

Step S72 is the case in which Cost per Click (CPC) is applied. The maximum profit rate is a numerical value that is calculated using the click rate and the bidding price in a specific period in which the advertiser client 200 has posted an advertisement, and the click rate is a numerical value that is calculated using the rate of the number of exposures for an advertisement to the number of clicks (maximum profit rate=bidding price click rate).

In the case where there is a history in which the same advertisement had been posted in the advertising area 300 selected by the advertiser client 200, the maximum profit rate is calculated using the click rate for the period in which the advertisement had been posted.

One or more advertiser clients 200 are selected from among a plurality of advertiser clients participating in an auction based on the bidding details so that they alone can post an advertisement in the advertising area 300.

A process of selecting an advertiser client 200 at step S72 of the bidding processing unit 130 of the auction server 100 selecting the advertiser client 200 in the order of the maximum profit rate will be described in detail below.

There are six advertiser clients A, B, C, D, E and F who desire to use a specific advertising area 300 on the Internet and post an advertisement on the specific advertising area 300. Currently, in the advertisement system of the present invention, four advertiser clients are intended to be selected for the advertising area 300. Of the six advertiser clients, advertiser clients A, B, C and D have posted advertisements in the advertising area 300, while advertiser clients E and F desire to post advertisements in the advertising area 300 for the first time. The average click rate of the advertising area 300 is 0.1. An auction is currently underway to select an advertiser client for the next period, and the bidding details of each of the advertiser clients are listed in the following Table 1:

TABLE 1

| | A | B | C | D | E | F |
|---|---|---|---|---|---|---|
| Bidding | 1000 | 300 | 200 | 100 | 500 | 100 |
| price | | | | | | |
| Click rate | 0.005 | 0.1 | 0.3 | 0.4 | 0.1 | 0.1 |
| Maximum | 5 | 30 | 60 | 40 | 50 | 10 |
| profit rate | | | | | | |

The maximum profit rate is calculated with 0.1, that is, the average click rate of the advertising area 300, assigned as the click rate of the advertiser clients E and F who are participating in the auction for the first time.

As a result, advertiser clients C, E, D and B are selected in the order of the maximum profit rate.

Although advertiser client A presents a bidding price higher than those of the other advertiser clients, because advertiser client A has an advertisement click rate that is considerably lower than those of the other advertiser clients for some reason, advertiser client A was not selected. This indicates that this method can increase the sales of the manager of the web site as compared to the method of selecting an advertiser client in the order of the bidding price.

Step S73 of the bidding processing unit 130 of the auction server 100 selecting an advertiser client 200 in the order of the bidding price is the case in which Cost Per Thousand impressions (CPM) is applied. One or more advertiser clients 200 are selected from among a plurality of advertiser clients 200 participating in the auction in the order of the bidding price so that they can post advertisements in the advertising area 300.

A process of selecting an advertiser client at step S73 of the bidding processing unit 130 of the auction server 100 selecting the advertiser client 200 in the order of the bidding price will be described in detail below using Table 1. At step S73, the advertiser client 200 is selected simply in the order of the bidding price, with the result that advertiser clients A, E, B and C are selected in the order of the bidding price if four advertiser clients are intended to be selected.

At step S80 of the advertisement transmission unit of the auction server 100 sending the advertisement of the selected advertiser client 200 to the advertising area 300, the advertisement transmission unit 140 sends the advertisement of the advertiser client 200, selected at step S70 of the bidding processing unit 130 of the auction server 100 selecting the advertiser client 200 who will post the advertisement in the advertising area 300, to the advertising area 300. The advertisement transmission unit 140 sends the advertisement, stored in the database unit 120, to the advertising area 300. The reason why two or more advertiser clients are selected such that they can post advertisements in the advertising area 300 is that the advertisements can be sent at different exposure rates in the order of the maximum profit rate or bidding price.

At step S90 of the web log processing unit 150 of the auction server 100 collecting the number of exposures and the number of clicks for an advertisement sent to the advertising area 300, the web log processing unit 150 of the auction server 100 collects the number of exposures and the number of clicks for the advertisement sent to the advertising area 300 on the Internet by the advertisement transmission unit 140, and stores it in the database unit 120.

At step S100, the fee processing unit 170 performs the settlement of advertising fees for the advertiser client 200 based on the number of exposures and the number of clicks for the advertisement collected by the web log processing unit 150.

Step S100 is divided into a case using CPC and a case using CPM depending on the method of calculating advertising fees used at the time of selecting the advertiser client 200.

First, in the case using CPC, advertising fees may be calculated using the number of clicks and the bidding price for the relevant advertising area 300 for a period in which the advertisement has been posted, and, in the case using CPM, advertising fees may be calculated using the number of exposures and the bidding price for the relevant advertising area 300 for a period in which the advertisement has been posted.

As a result, according to the present invention, an auction for the right to use an advertising area 300 of a specific web site is performed between advertiser clients who desire to post advertisements on the Internet, and the advertising area 300 on the Internet is provided to one or more advertiser clients 200 selected according to the bidding price. Accordingly, the manager of the advertising area on the Internet can maximize advertisement profits, and the advertiser clients 200 use the desired advertising area 300 on the Internet thereby achieving expected advertising effects and enabling the strategic management of advertising.

Although the present invention has been described in detail hitherto, it is clearly noted that the embodiments given in the description are only illustrative, and are not limitative. The replacement of elements with equivalent elements within a range that does not depart from the technical spirit or scope of the present invention provided by the accompanying claims falls within the range of the present invention.

1. An auction system for the right to use an advertising area on the Internet, the auction system selecting one or more advertiser clients, who have subscribed as members, have participated in bidding and will post advertisements, through an auction, the auction system including an auction server located on the Internet, wherein the auction server comprises:
a bidding interface unit for providing a plurality of advertising areas to the advertiser clients, providing detailed information including a number of exposures, a number of clicks, a lowest bidding price, and an average click rate (where the average click rate is calculated based on a rate of the number of exposures to the number of clicks, that is, a number of times Internet users select an advertisement exposed in the advertising area) for a past unit period for each of the plurality of advertising areas to the advertiser clients, providing bidding details, including bidding prices of remaining advertiser clients, who participate in an auction for the right to use the advertising area selected by the advertiser client, and a click rate, which was obtained during a specific period in which an advertisement had been posted, to the advertiser clients, and receiving bidding details, including a bidding price for an advertising area and location information of the advertising area, the advertising area being searched for and selected from among the plurality of advertising areas by the advertiser clients;
a database unit for storing bidding details input to the bidding interface unit;
a bidding processing unit for selecting one or more advertiser clients who will post advertisements in the advertising area in an order based on either their bidding price of bidding details, which is stored in the database unit and which corresponds to the advertising area selected by the advertiser clients, or a maximum profit rate (where maximum profit rate=bidding price click rate), which is stored in the database unit and which is a numerical value that is calculated using a click rate obtained during a specific period in which the advertiser clients had posted advertisements; and
an advertisement transmission unit for sending advertiser clients advertisements, selected by the bidding processing unit, to the advertising area.

2. The auction system as set forth in claim 1, wherein the bidding interface unit further provides a list of web sites and web pages, corresponding to the plurality of advertising areas, to the advertiser clients.

3. The auction system as set forth in claim 2, wherein the list of web sites and web pages corresponding to the plurality of advertising areas provided to the advertiser clients has a tree structure similar to that of Windows Explorer.

4. The auction system as set forth in claim 1, wherein the bidding interface unit further receives detailed information about the advertisement to be posted in the advertising area from each of the advertiser clients.

5. The auction system as set forth in claim 1, wherein the bidding processing unit periodically selects again one or more advertiser clients who will post advertisements in the advertising area in an order of the maximum profit rate for every specific period set in the auction server.

6. The auction system as set forth in claim 1, wherein, if the bidding processing unit selects two or more advertiser clients who will post advertisements in the advertising area, the advertisement transmission unit sends advertisements to the advertising area at different exposure rates based on the order of the maximum profit rate.

7. The auction system as set forth in claim 1, further comprising:
an account management unit for checking the balances of advertiser clients deposit accounts, and requesting the advertiser clients to deposit advertising fees;
a web log processing unit for collecting the number of exposures and the number of clicks for each of the advertisements of the selected advertiser clients sent from the advertisement transmission unit, and storing it in the database unit; and
a fee processing unit for performing settlement of advertising fees for the advertiser clients, selected by the bidding processing unit, based on the number of exposures and the number of clicks for the advertisements collected by the web log processing unit.

8. A method of operating an auction system for the right to use an advertising area on an Internet, the auction system selecting one or more advertiser clients, who have subscribed as members, have participated in bidding and will post advertisements, through an auction, the auction system including an auction server located on the Internet, the method comprising:
a first step of a bidding interface unit of the auction server providing a plurality of advertising areas to the advertiser clients, providing detailed information including a number of exposures, a number of clicks, a lowest bidding price, and an average click rate (where the average click rate is calculated based on a rate of the number of exposures to the number of clicks, that is, a number of times Internet users select an advertisement exposed in the advertising area) for a past unit period for each of the plurality of advertising areas to the advertiser clients, and providing bidding details, including bidding prices of remaining advertiser clients, who participate in an auction for the right to use the advertising area selected by the advertiser client, and a click rate, which was obtained during a specific period in which an advertisement had been posted, to the advertiser clients;
a second step of the advertiser clients selecting any one from among the plurality of advertising areas provided by a bidding interface unit of the auction server, and a bidding interface unit of the auction server receiving bidding details, including bidding prices, entered for the selected advertising area by the advertiser clients, and location information of the selected advertising area;
a third step of a database unit of the auction server storing bidding details input to the bidding interface unit;
a fourth step of a bidding processing unit of the auction server checking whether or not the end of an auction period has been reached, and selecting one or more advertiser clients who will post advertisements in the advertising area in an order based on their bidding price of bidding details, which is stored in the database unit and which corresponds to the advertising area selected by the advertiser clients, and a maximum profit rate (where maximum profit rate=bidding price click rate), which is stored in the database unit and which is a numerical value that is calculated using a click rate obtained during a specific period in which the advertiser clients had posted advertisements; and
a fifth step of an advertisement transmission unit of the auction server sending advertiser clients advertisements, selected by the bidding processing unit, to the advertising area.

9. The method as set forth in claim 8, wherein the first step further comprises the bidding interface unit of the auction server further providing a list of web sites and web pages, corresponding to the plurality of advertising areas, to the advertiser clients.

10. The method as set forth in claim 8, further comprising, after the fifth step, selecting again one or more advertiser clients who will post advertisements in the advertising area by periodically repeating the fourth step for every specific period set in the auction server.

11. The method as set forth in claim 8, wherein the fifth step comprises, if the bidding processing unit of the auction server selects two or more advertiser clients who will post advertisements in the advertising area based on the maximum profit rate at the fourth step, sending advertisements to the advertising area at different exposure rates based on the order of the maximum profit rate.

12. The method as set forth in claim 8, further comprising:
before the first step, a step of the bidding interface unit of the auction server receiving advertiser clients membership subscriptions, connecting with the auction server, and a step of the account management unit of the auction server checking the balances of advertiser clients deposit accounts, and a step of the bidding interface unit of the auction server receiving advertisements from the advertiser clients; and
after the fifth step, a step of the web log processing unit of the auction server collecting a number of exposures and a number of clicks for each of the advertisements sent to the advertising area, and a step of the fee processing unit of the auction server performing settlement of advertising fees for the advertiser clients based on the number of exposures and the number of clicks for the advertisements collected by the web log processing unit of the auction server.
